(19) United States
(12) Patent Application Publication
(10) Pub. No.: US 2015/0235164 A1
(43) Pub. Date: Aug. 20, 2015

(54) Role-Based Control of Incident Response in a Secure Collaborative Environment

(71) Applicant: Cybersponse, Inc., Scottsdale, AZ (US)

(72) Inventor: William Key, Anthem, AZ (US)

(73) Assignee: Cybersponse, Inc., Scottsdale, AZ (US)

(21) Appl. No.: 14/703,881

(22) Filed: May 4, 2015

Related U.S. Application Data
(63) Continuation-in-part of application No. 14/216,570, filed on Mar. 17, 2014.
Application No. 14/216,570 is a continuation-in-part of application No. 14/630,383, filed on Feb. 24, 2015.
(60) Provisional application No. 61/988,149, filed on May 2, 2014.
(60) Provisional application No. 61/799,882, filed on Mar. 15, 2013.
(60) Provisional application No. 61/943,564, filed on Feb. 24, 2014.

(51) Int. Cl. G06Q 10/06; G06Q 50/18

(52) U.S. Cl. CPC G06Q 10/063118; G06Q 50/18

(57) ABSTRACT

Various systems and method for incident response may benefit from role-based control. More particularly, role-based control of incident response may be of benefit in a secure collaborative environment. A method can include determining, by a computer for a computer-controlled workflow, whether filtering is activated. The method can also include determining, by the computer when filtering is activated, whether a threshold severity level is met by the workflow or whether a critical data type is implemented in the workflow. The method can further include alerting, by the computer, an attorney about the workflow when the threshold is met or the critical data type is implemented.

### CROSS REFERENCE TO RELATED APPLICATIONS

This application is related to and claims the benefit and priority of U.S. Provisional Patent Application No. 61/988,149 (the '149 application), filed May 2, 2014. This application is also a continuation-in-part of U.S. patent application Ser. No. 14/216,570 (the '570 application), filed Mar. 17, 2014, and claims the benefit and priority of U.S. Provisional Patent Application No. 61/799,882 (the '882 application), filed Mar. 15, 2013. This application is also a continuation-in-part of U.S. patent application Ser. No. 14/630,383 (the '383 application), filed Feb. 24, 2015, and claims the benefit and priority of U.S. Provisional Patent Application No. 61/943,564 (the '564 application), filed Feb. 24, 2014. Each of the '149 application, the '570 application, the '882 application, the '383 application, and the '564 application is hereby incorporated herein by reference in its entirety.

### BACKGROUND

1. Field

Various systems and method for incident response may benefit from role-based control. More particularly, role-based control of incident response may be of benefit in a secure collaborative environment.

2. Description of the Related Art

Various workflow management systems may relate to incident response systems. However, such systems for incident response do not provide appropriate mechanisms and methods for addressing issues such as, for example, attorney-client privilege, work product privilege, confidentiality, and the like, at an early stage.

### SUMMARY

According to certain embodiments, a method can include determining, by a computer for a computer-controlled workflow, whether filtering is activated. The method can also include determining, by the computer when filtering is activated, whether a threshold severity level is met by the workflow or whether a critical data type is implemented in the workflow. The method can further include alerting, by the computer, an attorney about the workflow when the threshold is met or the critical data type is implemented.

In certain embodiments, an apparatus can include at least one processor and at least one memory including computer program code. The at least one memory and the computer program code can be configured to, with the at least one processor, cause the apparatus at least to determine, for a computer-controlled workflow, whether filtering is activated. The at least one memory and the computer program code can also be configured to, with the at least one processor, cause the apparatus at least to determine, when filtering is activated, whether a threshold severity level is met by the workflow or whether a critical data type is implemented in the workflow. The at least one memory and the computer program code can further be configured to, with the at least one processor, cause the apparatus at least to alert an attorney about the workflow when the threshold is met or the critical data type is implemented.

A non-transitory computer-readable medium can, according to certain embodiments, be encoded with instructions that, when executed in hardware, perform a process. The process can include determining, by a computer for a computer-controlled workflow, whether filtering is activated. The process can also include determining, by the computer when filtering is activated, whether a threshold severity level is met by the workflow or whether a critical data type is implemented in the workflow. The process can further include alerting, by the computer, an attorney about the workflow when the threshold is met or the critical data type is implemented.

An apparatus, in certain embodiments, can include means for determining, for a computer-controlled workflow, whether filtering is activated. The apparatus can also include means for determining, when filtering is activated, whether a threshold severity level is met by the workflow or whether a critical data type is implemented in the workflow. The apparatus can further include means for alerting an attorney about the workflow when the threshold is met or the critical data type is implemented.

### BRIEF DESCRIPTION OF THE DRAWINGS

For proper understanding of the invention, reference should be made to the accompanying drawings, wherein:

FIG. 1 is a process flow diagram illustrating a high-level workflow of an embodiment of a role-based control of a secure collaborative environment.

FIG. 2 is a process flow diagram illustrating a workflow choice process wherein the lead role can decide on a type of workflow to be utilized as well as how the workflow will be executed.

FIG. 3 is a process flow diagram illustrating an automated process to require verification and guidance as tasks are assigned and completed for a chosen workflow.

FIG. 4 is a process flow diagram illustrating a directed-by-lead-role method of executing a chosen workflow.

FIG. 5 illustrates the automatic keyword triggering process that may be implemented to further automate the process for keeping incident response communications and actions confidential and, in certain embodiments, privileged.

FIG. 6 illustrates a system according to certain embodiments of the invention.

### DETAILED DESCRIPTION

The structure, overall operation and technical characteristics of the present invention will become apparent with the detailed description of certain embodiments and the illustration of the related drawings.

Role-based control of an incident response (IR) process in a secure collaborative environment can be performed on a computer system, sometimes referred to as an incident response platform (IRP). A method of role-based control, and the corresponding system, can be designed to maintain confidentiality of the incident response process at all times, while also allowing various user roles to take the lead and have varying degrees of control over the process. Such an approach may facilitate the execution of an organization's incident response policies in whatever manner the organization has determined to be appropriate.

In certain embodiments, the user in the lead role can be responsible for determining what policies and workflows to apply to maintain confidentiality. One example may be when either in-house or outside counsel takes on a lead role in applying legal analysis to one or more steps of a response process. Such involvement may be undertaken at an early stage in order to maximize possible attorney-client privilege.

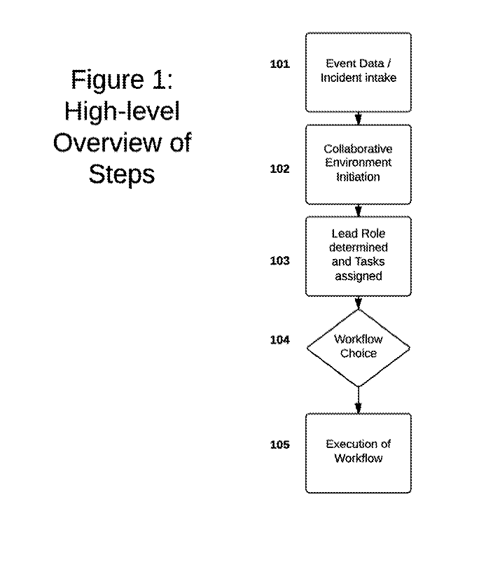

FIGS. 1-5 illustrates various embodiments of a method and system for maintaining process control of a cyber-security incident response team by a lead role during an incident response process.

FIG. 1 shows a high level overview of a basic process of certain embodiments for maintaining control as a lead role. The incident response platform can be designed to receive event data or incident data from outside systems such as intrusion detection systems, antivirus, security information and event management systems, or any other system designed to detect cyber security events. This intake of event data and report of an incident is illustrated in step 101.

After event data or incident data is received by the incident response platform at 101, the secure collaborative environment can be initiated in step 102. One or more connections to the secure collaborative environment can be encrypted using any desired mechanism, such as Hypertext Transfer Protocol Secure (HTTPS). Further, only users pre-designated to access the system may be allowed to communicate by sending or receiving data. This limitation on users may be achieved through the storing of unique login credentials in an encrypted user database, or by other authentication mechanisms. Login to the incident response platform can be further secured through two-factor authentication techniques. The two-factor authentication techniques may require login credentials, such as username and password, and another form at the option of the user, including, but not limited to, a code sent via short message service (SMS) to the user, an authentication application on the user's smartphone, an encrypted dongle, or any other secondary mechanism for unique identification of the user.

The secure collaboration environment of the incident response platform can contain the ability for users to communicate with each other through instant messaging, chat rooms, file sharing, white boarding, event feeds, user alerts and notifications, internal messaging, internal email, conference calling, SMS messaging, group SMS messaging, and other communication techniques including multimedia messaging.

In step 103, a lead role can be determined. The lead role may be automatically designated or manually designated. The manual designation may be performed by a user having sufficient authorization, or by other mechanisms such as by voting amongst active users. The user in the lead role can command the incident response process. The lead role can refer to a user equivalent to a Chief Information Security Officer of an organization, a lead member of the incident response team, or, in certain embodiments, an attorney to coordinate the actions of the incident response team. In this step, the lead role can be assigned initial tasks to be completed to begin the coordination of the incident response team. These tasks may include an initial analysis of the event data or incident data received by the incident response platform in step 101. The lead role may make a determination as to whether to mobilize the incident response team and the proper course of action for the incident response team at this or any other desired time.

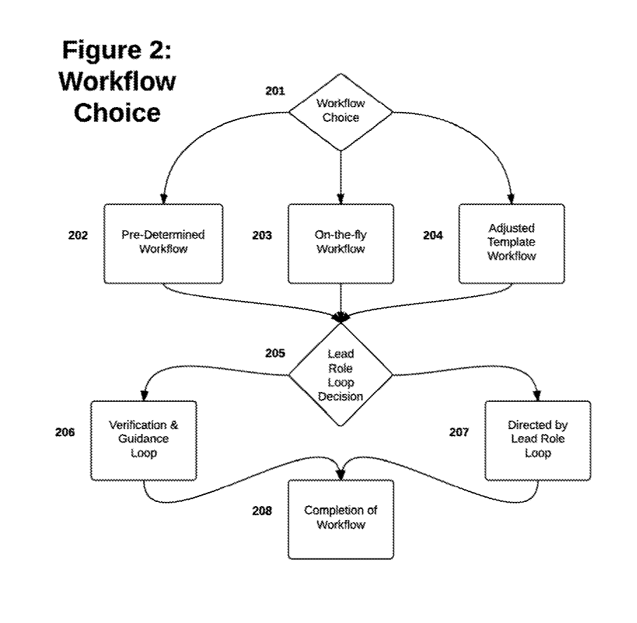

In step 104, the lead role can make a decision about which workflow to execute and the method for such execution. In this step, the lead role can have options to use automated workflows, manually created workflows, or a combination of both. The lead role can also determine the method for maintaining control of the process of the incident response team. This process can be further seen by the illustrated provided in the example of FIG. 2.

In step 105, the lead role can oversee the execution of the chosen workflow. The lead role can also coordinate communications among the incident response team. The lead role can see the incident response process through until the incident is rectified.

FIG. 2 illustrates an exemplary process by which the lead role may determine that the incident response team is to proceed under a particular workflow. In step 201, the lead role can be presented with the event data or incident data received in step 101 and can be given a choice through a graphical user interface as to how to create a workflow for the incident response team to proceed. In certain embodiments, the lead role can apply the lead role's expertise in applying best practices and/or legal standards to the choice in determining which type of workflow to utilize.

In step 202, the lead role may choose to utilize a pre-determined workflow that is stored in a database. Pre-determined workflows may have been previously created by users, including for example the user in the lead role. Alternatively, the pre-determined workflows may have been provided by the incident response platform vendor or built automatically by the incident response platform itself.

In step 203, the lead role may choose to build a workflow on-the-fly for the incident response team. In this step, the lead role may apply its knowledge of legal standards to create a workflow.

In step 204, the lead role may choose from pre-existing template workflows that are stored in a database and manually alter them to fit the current incident.

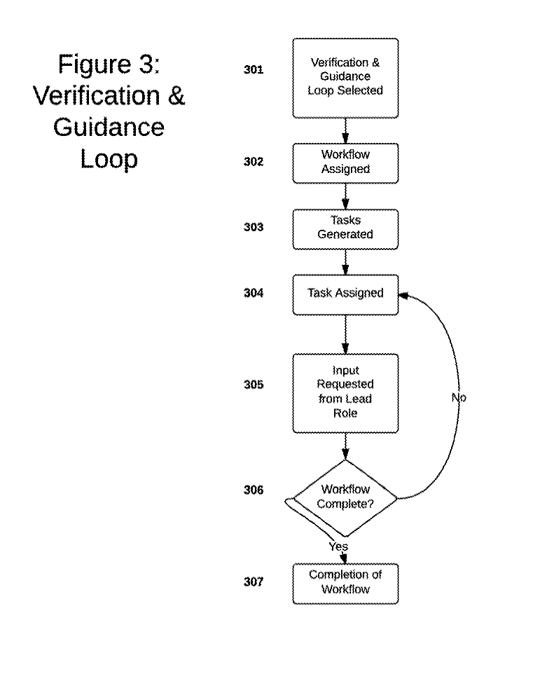

After the choice of workflow type has been made by the lead role, the lead role can then choose, in step 205 what type of lead role loop is to be utilized for the execution of the workflow. In step 206, the lead role may choose to use a verification and guidance loop, illustrated in FIG. 3.

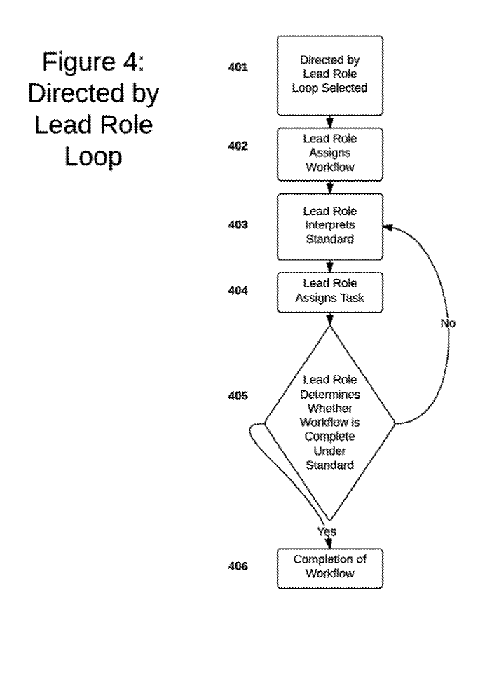

In step 207, the lead role may choose to use the directed-by-lead-role loop, illustrated in FIG. 4.

Step 208 represents the completion of the workflow by the incident response team under the direction of the lead role.

FIG. 3 illustrates an exemplary process by which the lead role may manage the incident response team using the verification and guidance loop. In step 301, the lead role can select the verification and guidance loop, which may have any similar descriptive name in the incident response platform, through the user interface.

In step 302, the lead role can assign the workflow chosen earlier in step 201. The lead role can be presented with a list of the members of the incident response team that may be included in the workflow assignment. This list can be populated through previous role-assignments stored in the database. In this step, the lead role may make a determination as to which team members or role types to include in the workflow assignment.

In step 303, tasks may be generated to remedy the incident based on the workflow chosen by the lead role. The task generation may be automatically performed by the incident response platform or manually by the lead role.

In step 304, the tasks generated in step 303 may be assigned to members of the incident response team. The tasks may be assigned according to role or according to person or by any other desired standard. The lead role may decide whether and to whom to assign tasks. The tasks may also be assigned automatically by the incident response platform.

In step 305, input can be requested of the lead role as to whether to proceed with an assigned task. The lead role may utilize the lead role's expertise and/or apply legal standards to approve an assigned task. The lead role can also provide the incident response team member to whom the task was assigned with guidance on how to perform the task. The approval process can be performed using the incident response platform graphical user interface on the lead role's console.

Any guidance or communications between the lead role and the incident response team member can be done through the incident response platform secure communications system or any other desired communications system. In the event that an incident response team member needs to communicate with another incident response team member, that communication may be filtered through the lead role to determine whether the communication should take place and whether the content of such communication should be sent as is or edited. The lead role may further provide continuing guidance through the secure communications (or other) platform to incident response team members, as well as direct group communications through the other methods of communication within the incident response platform.

In step 306, a determination can be made as to whether the assigned workflow has been completed. This determination may be done automatically by the incident response platform or manually by the lead role, for example. If it is determined that the workflow is not complete, and the incident has not been remedied, the process can return to step 304 where additional tasks may be assigned to incident response team members.

If it is determined that the incident has been remedied and no further tasks are needed, the process can end at step 307 and the incident can be considered resolved.

FIG. 4 illustrates an exemplary process by which the lead role may manage the incident response team using a directed-by-lead-role loop. In step 401, the lead role can select the directed-by-lead-role loop, which may have any similar descriptive name in the incident response platform, through the user interface.

In step 402, the lead role may assign the workflow chosen earlier in step 201. The lead role may be presented with a list of the members of the incident response team that may be included in the workflow assignment. This list may be populated through previous role-assignments stored in the database. In this step, the lead role may make a determination on which team members or role types to include in the workflow assignment.

In step 403, the lead role can interpret industry and/or legal standards to apply to handle the type of incident that the incident response team aims to remedy. The lead role in this step may further adjust the workflow to comply with the lead role's understanding of the industry and/or legal standards for conducting the response. In this step, the lead role may coordinate with the incident response team using the secure communications system (or any other desired communications system) to ensure that the incident response team understands the workflow and requirements thereof.

In step 404, the lead role may assign tasks to members of the incident response team according to the lead role's interpretation of the industry and/or legal standards for conducting the response. The lead role may utilize the secure communications system to assign these tasks. After the tasks have been assigned in this step, the lead role may continue to communicate using the secure communications system with the incident response team members and direct them on how to complete the response process. In one embodiment, all (or a subset thereof) communications between incident response team members may be sent to the lead role to determine whether the communication should take place and whether the content of such communication should be sent as is or edited. The lead role may further provide continuing guidance through the secure communications platform with incident response team members as well as direct group communications through the other methods of communication within the incident response platform.

In step 405, the lead role can make a determination as to whether the incident has been completed and can make a determination as to whether the workflow is complete according to the industry and/or legal standards that the lead role has applied to the process. If the lead role determines that the workflow has not been completed, the lead role may choose to return to step 403 and interpret the standard again. The lead role can also assign additional tasks to incident response team members. If the lead role determines that the workflow has been completed and the incident has been resolved, the lead role may end the workflow and mark the incident as resolved with a user interface.

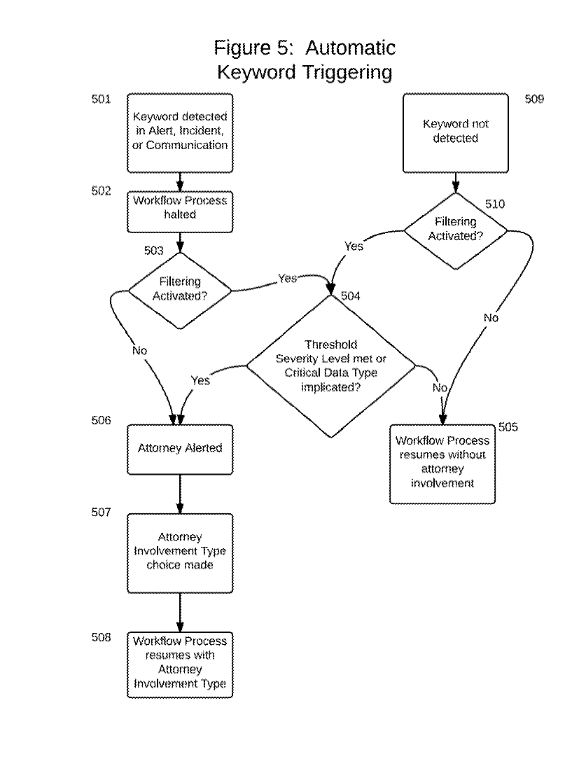

FIG. 5 illustrates an exemplary automatic keyword triggering process that may be implemented to further automate the process for keeping incident response communications and actions confidential and, in certain embodiments, privileged.

In certain embodiments, a pre-defined set of keywords can be stored in a database that a user has determined may give rise to the need for heightened protection of the communications. For example, the pre-defined set of keywords could include words such as “fault,” “mistake,” “error,” or “failed,” or names, such as names of personnel or names of customers. In any case, the list can comprise a dynamic list of whatever words the user wishes to trigger enhanced scrutiny.

In step 501, if a communication, incoming alert, incident record, or anything else defined by the user, contains one or more of the keywords, the system can detect the keyword and begin one of the automatic keyword triggering processes. The system can also, in step 502, halt any workflow processes that may be in progress for the related event or incident.

The system can then determine whether filtering has been activated in step 503. Filtering in the automatic keyword triggering process can be a determination whether a specific threshold severity level or critical data type is present in the related event or incident record. Threshold severity levels may be descriptive values such as “low,” “medium,” “high,” “severe,” “critical,” or other such values. Threshold severity levels to be utilized may be generated or set by connected alerting tools, the system itself, or according to a user's choice. Threshold severity levels may also be quantitative scores based on industry standard formulas such as provided by the National Institute of Standards and Technology (NIST) or the Common Vulnerability Scoring System (CVSS), or may be custom-built by the user as well.

Critical data types may be designations of the specific types of data that may be implicated or compromised in an event or incident and may include personally identifiable information (PH), personal health information (PHI), payment card information (PCI), or any other type of data that the user or organization wishes to designate as important enough to trigger additional scrutiny or protection of the response process.

If filtering is enabled, the system can proceed to step 504 and determine whether a threshold severity level or critical data type is present in the related event or incident record, for example based on user settings. If either is present, the system can proceed to step 506.

If filtering is not enabled, the system can proceed from step 503 directly to step 506. In step 506, an attorney can be automatically alerted via email, SMS, automated phone call, or other communications method(s) that an event or incident requires the attorney's attention.

After being alerted, the attorney can then be presented with an attorney involvement type choice in step 507. The attorney may elect to self-manage the event or incident, passively observe the response process, or deputize another lead for the response team to act on his or her behalf in a legal capacity. Depending on the attorney involvement type, attorney-client privilege may be maintained over some or most of the communications that occur during the response process. Alternatively, not shown in FIG. 5, the attorney may elect to discontinue attorney involvement, and the process may proceed to step 505.

After the selection of the attorney involvement type, the response process may resume according to whatever workflow process was associated with the event or incident in step 508 with attorney involvement according to the attorney involvement type.

If filtering was active in step 503 but neither the threshold severity level nor critical data type were implicated in step 504, the response process can resume according to whatever workflow process was associated with the event or incident without attorney involvement in step 505.

Alternatively, if a keyword was not detected in a communication, incoming alert, incident record, or anything else defined by the user in step 509, the system can still determine whether filtering is activated in step 510. If filtering is active, the process may proceed to step 504, discussed above.

If filtering is not active in step 510, the response process can resume according to whatever workflow process was associated with the event or incident without attorney involvement in step 505.

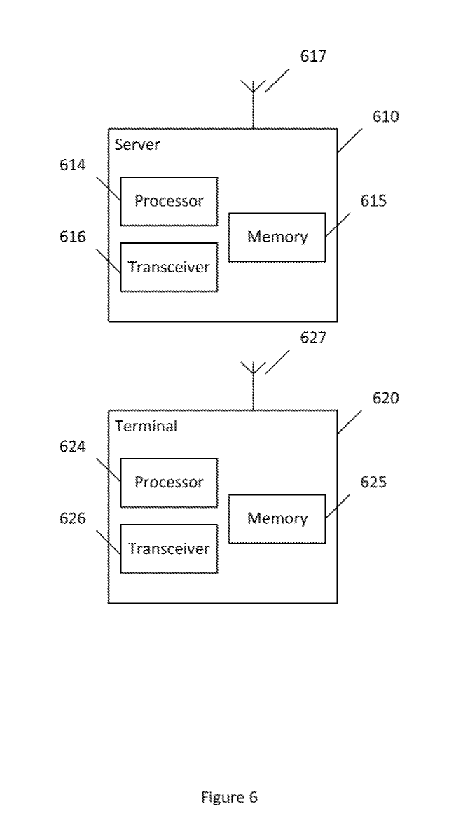

FIG. 6 illustrates an exemplary system according to certain embodiments of the invention. It should be understood that each block of the flowchart of any of FIGS. 1-5 may be implemented by various means or their combinations, such as hardware, software, firmware, one or more processors and/or circuitry. In one embodiment, a system may include several devices, such as, for example, server 610 and terminal 620. The system may include more than one terminal 620 and more than one server 610, although only one of each is shown for the purposes of illustration. A server can be any computer system, including a network server, a cloud server, or the like.

Each of these devices may include at least one processor or control unit or module, respectively indicated as 614 and 624. At least one memory may be provided in each device, and indicated as 615 and 625, respectively. The memory may include computer program instructions or computer code contained therein, for example for carrying out the embodiments described above. One or more transceiver 616 and 626 may be provided, and each device may also include an antenna, respectively illustrated as 617 and 627. Other configurations of these devices, for example, may be provided. For example, server 610 and terminal 620 may be configured for wired or wireless communication and in such cases antennas 617 and 627 may illustrate any form of communication hardware, without being limited to an antenna.

Transceivers 616 and 626 may each, independently, be a transmitter, a receiver, or both a transmitter and a receiver, or a unit or device that may be configured both for transmission and reception.

A terminal 620 may be a mobile phone, smart phone, multimedia device, a computer, such as a tablet, personal data or digital assistant (PDA), or the like.

Processors 614 and 624 may be embodied by any computational or data processing device, such as a central processing unit (CPU), digital signal processor (DSP), application specific integrated circuit (ASIC), programmable logic devices (PLDs), field programmable gate arrays (FPGAs), digitally enhanced circuits, or comparable device or a combination thereof. The processors may be implemented as a single controller, or a plurality of controllers or processors. Additionally, the processors may be implemented as a pool of processors in a local configuration, in a cloud configuration, or in a combination thereof.

For firmware or software, the implementation may include modules or unit of at least one chip set (e.g., procedures, functions, and so on). Memories 615 and 625 may independently be any suitable storage device, such as a non-transitory computer-readable medium. A hard disk drive (HDD), random access memory (RAM), flash memory, or other suitable memory may be used. The memories may be combined on a single integrated circuit as the processor, or may be separate therefrom. Furthermore, the computer program instructions may be stored in the memory and which may be processed by the processors can be any suitable form of computer program code, for example, a compiled or interpreted computer program written in any suitable programming language. The memory may be fixed or removable.

The memory and the computer program instructions may be configured, with the processor for the particular device, to cause a hardware apparatus such as server 610 and/or terminal 620, to perform any of the processes described above (see, for example, FIGS. 1-5). Therefore, in certain embodiments, a non-transitory computer-readable medium may be encoded with computer instructions or one or more computer program (such as added or updated software routine, applet or macro) that, when executed in hardware, may perform a process such as one of the processes described herein. Computer programs may be coded by a programming language, which may be a high-level programming language, such as objective-C, C, C++, C#, Java, etc., or a low-level programming language, such as a machine language, or assembler. Alternatively, certain embodiments of the invention may be performed entirely in hardware.

For example, certain embodiments may be configured to perform a method. The method can include determining, by a computer such as terminal 610 for a computer-controlled workflow, whether filtering is activated. The method can also include determining, by the computer when filtering is activated, whether a threshold severity level is met by the workflow or whether a critical data type is implemented in the workflow. The method can further include alerting, by the computer, an attorney about the workflow when the threshold is met or the critical data type is implemented.

The method can also include suspending, by the computer, the workflow until an attorney involvement type selection is made. The method can further include resuming, by the computer, the workflow upon the attorney involvement type selection being made. The method can additionally include controlling, by the computer, the workflow in accordance with the attorney involvement type selection.

Control of the workflow in accordance with the attorney involvement type selection can involve routing at least a portion of communications of the workflow through the attorney or a person designated by the attorney. For example, in certain embodiments, all communications of the workflow may be so routed.

Alternatively, or in addition, control of the workflow in accordance with the attorney involvement type selection can involve altering at least one of a content or a header of communications of the workflow based on the attorney involvement type selection. For example, a header of “privileged and confidential” or “attorney-client privileged” may be added to communications to and from the attorney, depending on the attorney involvement selection.

Similarly, other content changes may be made. For example, PH or PHI, or the like, may be redacted prior to the communications being distributed amongst team members of incident response team.

The method can further include detecting, by the computer, at least one keyword in an alert, incident report, or communication of the workflow. The method can also include halting, by the computer, the workflow when the at least one keyword is detected. The method can additionally include alerting, by the computer when the filtering is not activated, the attorney about the workflow based on the detected at least one keyword.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

What is claimed is:

1. A method, comprising:
determining, by a computer for a computer-controlled workflow, whether filtering is activated;
determining, by the computer when filtering is activated, whether a threshold severity level is met by the workflow or whether a critical data type is implemented in the workflow; and
alerting, by the computer, an attorney about the workflow when the threshold is met or the critical data type is implemented.

2. The method of claim 1, further comprising:
suspending, by the computer, the workflow until an attorney involvement type selection is made.

3. The method of claim 2, further comprising:
resuming, by the computer, the workflow upon the attorney involvement type selection being made; and
controlling, by the computer, the workflow in accordance with the attorney involvement type selection.

4. The method of claim 3, wherein control of the workflow in accordance with the attorney involvement type selection comprises routing at least a portion of communications of the workflow through the attorney or a person designated by the attorney.

5. The method of claim 3, wherein control of the workflow in accordance with the attorney involvement type selection comprises altering at least one of a content or a header of communications of the workflow based on the attorney involvement type selection.

6. The method of claim 1, further comprising:
detecting, by the computer, at least one keyword in an alert, incident report, or communication of the workflow;
halting, by the computer, the workflow when the at least one keyword is detected; and
alerting, by the computer when the filtering is not activated, the attorney about the workflow based on the detected at least one keyword.

7. An apparatus, comprising:
at least one processor; and
at least one memory including computer program code,
wherein the at least one memory and the computer program code are configured to, with the at least one processor, cause the apparatus at least to
determine, for a computer-controlled workflow, whether filtering is activated;
determine, when filtering is activated, whether a threshold severity level is met by the workflow or whether a critical data type is implemented in the workflow; and
alert an attorney about the workflow when the threshold is met or the critical data type is implemented.

8. The apparatus of claim 7, wherein the at least one memory and the computer program code are configured to, with the at least one processor, cause the apparatus at least to
suspend the workflow until an attorney involvement type selection is made.

9. The apparatus of claim 8, wherein the at least one memory and the computer program code are configured to, with the at least one processor, cause the apparatus at least to
resume the workflow upon the attorney involvement type selection being made; and
control the workflow in accordance with the attorney involvement type selection.

10. The apparatus of claim 9, wherein control of the workflow in accordance with the attorney involvement type selection comprises routing at least a portion of communications of the workflow through the attorney or a person designated by the attorney.

11. The apparatus of claim 9, wherein control of the workflow in accordance with the attorney involvement type selection comprises altering at least one of a content or a header of communications of the workflow based on the attorney involvement type selection.

12. The apparatus of claim 7, wherein the at least one memory and the computer program code are configured to, with the at least one processor, cause the apparatus at least to:
detect at least one keyword in an alert, incident report, or communication of the workflow;
halt the workflow when the at least one keyword is detected; and
alert, by the computer when the filtering is not activated, the attorney about the workflow based on the detected at least one keyword.

13. A non-transitory computer-readable medium encoded with instructions that, when executed in hardware, perform a process, the process comprising:
determining, by a computer for a computer-controlled workflow, whether filtering is activated;
determining, by the computer when filtering is activated, whether a threshold severity level is met by the workflow or whether a critical data type is implemented in the workflow; and
alerting, by the computer, an attorney about the workflow when the threshold is met or the critical data type is implemented.

14. The non-transitory computer-readable medium of claim 13, further comprising:
suspending, by the computer, the workflow until an attorney involvement type selection is made.

15. The non-transitory computer-readable medium of claim 14, further comprising:
resuming, by the computer, the workflow upon the attorney involvement type selection being made; and
controlling, by the computer, the workflow in accordance with the attorney involvement type selection.

16. The non-transitory computer-readable medium of claim 15, wherein control of the workflow in accordance with the attorney involvement type selection comprises routing at least a portion of communications of the workflow through the attorney or a person designated by the attorney.

17. The non-transitory computer-readable medium of claim 15, wherein control of the workflow in accordance with the attorney involvement type selection comprises altering at least one of a content or a header of communications of the workflow based on the attorney involvement type selection.

18. The non-transitory computer-readable medium of claim 11, further comprising:
detecting, by the computer, at least one keyword in an alert, incident report, or communication of the workflow;
halting, by the computer, the workflow when the at least one keyword is detected; and
alerting, by the computer when the filtering is not activated, the attorney about the workflow based on the detected at least one keyword.
